(19) United States
(12) Patent Application Publication
(10) Pub. No.: US 2011/0180448 A1
(43) Pub. Date: Jul. 28, 2011

(54) PACKAGING SYSTEM FOR SEPARATELY STORING AND DISPENSING TOGETHER SEPARATE MEDICATION COMPONENTS

(76) Inventors: Rajneesh Taneja, Libertyville, IL (US); Pramod Gupta, Pittsford, NY (US)

(21) Appl. No.: 12/979,486

(22) Filed: Dec. 28, 2010

Related U.S. Application Data
(63) Continuation of application No. 10/322,917, filed on Dec. 18, 2002, now abandoned.
(60) Provisional application No. 60/342,033, filed on Dec. 19, 2001.

(51) Int. Cl. A61J 1/03; B65D 83/04

(52) U.S. Cl. 206/531; 206/534

(57) ABSTRACT

The present invention relates to a packaging system intended to simplify the usage of multiple medications stored separately and used together, thereby minimize the non-compliant use of the multiple medications. Generally, the separate medications are grouped together on a per dose basis in a plurality of blister pack recesses. A single cover sheet is used to commonly seal the related medications to be used together, such that when the corresponding cover sheet is removed the multiple medications are commonly accessed.

This application claims priority from U.S. Provisional Application Ser. No. 60/342,033, filed Dec. 19, 2001.

### FIELD OF THE INVENTION

The invention pertains to a packaging system for separately storing and dispensing together separate medication components. More specifically, the invention pertains to a blister package whereby a single shearing force releases the multiple separate medication components, which are to be used together in a single dose, but kept separate prior to usage.

### BACKGROUND OF THE INVENTION

Noncompliance with prescription medications has been identified as a major health care concern in the United States. At least one study has estimated that nearly 50 percent of all drugs are not taken as prescribed. As a result an estimated $100 billion is spent annually on lost productivity and unnecessary medical costs, such as doctor visits, hospitalizations, and nursing-home admissions. A further study has estimated that noncompliance with prescription medications causes 125,000 deaths, annually.

In some instances, patient noncompliance may be unintentional. Complex medication regimens can sometimes confuse even the most alert of patients. However when coupled with reduced memory capacity like that resulting from dementia, mental illness, or even less severe natural degradations in mental facilities due to aging, patient compliance becomes that much more difficult.

In other instances, patient noncompliance may be intentional. Pain, for example from arthritis, or other physical impairments, like difficulty swallowing, can sometimes deter patients from taking their medication as prescribed. Sometimes a patient's self comparison of the perceived side effects versus the perceived benefits of taking prescribed medication may lead to a patient's voluntary medication noncompliance.

In those instances where the side effects are real, the side effects can sometimes be treated and/or minimized by supplementing the original prescription with an additional medication directed to dealing with the side effects experienced. However, any additional medications being prescribed can only contribute to the complexity of the patient's prescription medication regimen. Depending on how complex the patient's prescription regimen already is, a doctor may be reluctant to prescribe additional medications, especially where compliance issues may already exist.

Several systems have been developed for simplifying the complexity associated with taking multiple medications. However in many instances these systems impose a regimen which may include additional steps. For example, medications which are to be taken over a period of time can be organized into a tray, which includes multiple compartments, where each compartment is adapted to hold all the medications to be taken by the patient at a particular predetermined time. One of the potential drawbacks associated with a system of this type is the ability of the different medications to come into physical contact with one another prior to being taken. This allows different medications to potentially interact, where often times the potential effect is generally unknown.

In other instances, systems of this type have an additional cost associated with them including the cost of the equipment and materials used to implement the procedure. Some patients are unwilling to incur these additional expenses, that might be associated with more structured systems or as part of the medication packaging, even though they may be one time expenses and/or relatively minor, but still not minor enough. Consequently, any more structured approach or system, that is incorporated as part of the medication's packaging, should minimize the financial impact upon the patient.

Consequently, it would be beneficial to develop a packaging system by which multiple medications or medication components can be separately stored and dispensed together, and which reduces the burdens associated with taking the multiple medications or medication components, as prescribed.

Still further, it would similarly be beneficial to develop a packaging system, where the medication components are prevented from coming into contact with one another, and are substantially physically isolated from the environment outside of the package system prior to dispensing.

### SUMMARY OF THE INVENTION

A package system is provided for separately storing and dispensing together separate medication components. The package system provides a blister sheet including a plurality of blister recesses for receiving a plurality of different medication components. The different medication components, which are to be used together on a per dose basis, are grouped in adjacent blister recesses. The blister sheet further includes a substantially planar non-blistered shoulder portion, which extends around at least portions of the plurality of blister recesses.

The package system further provides a backing sheet having one or more openings, where each opening is opposite to and extends to encompass one or more of the blister recesses, which include medication components from the same usage grouping. The backing sheet further has a sealing portion, which is substantially adhered to the shoulder portion of the blister sheet.

One or more cover sheets are used to cover and seal the one or more openings in the backing sheet. A common cover sheet covers all of the one or more openings opposite the blister recesses containing the medication components of a specific usage grouping.

In one aspect of the invention the cover sheets are secured to the backing sheet using a glue, which readily tears away from the backing sheet, at least partially, when a shearing force is applied.

In another aspect of the invention, product information regarding the medication components is provided on at least one of the backing sheet and the cover sheet.

In a further embodiment, a package system is provided for separately storing and dispensing together separate medication components. The package system provides a blister sheet including a plurality of blister recesses for receiving a plurality of different medication components. The different medication components, which are to be used together on a per dose basis, are grouped in adjacent blister recesses. The blister sheet further includes a substantially planar non-blistered shoulder portion, which extends around at least portions of the plurality of blister recesses.

The package system further provides a backing sheet having a sealing portion, which is substantially adhered to the shoulder portion of the blister sheet. The backing sheet is subdivided into one or more segmented portions. Each segmented portion is opposite to, and extends to encompass and substantially seal one or more of the blister recesses, which include all of the medication components of a specific usage grouping.

In one aspect of the invention the one or, more segments of the backing sheet are defined by weakened areas in the backing sheet along which the backing sheet tears as a shearing force is applied by the user to one of the segmented portions

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is an isometric view of a blister package for separately storing and dispensing together separate medication components, in accordance with the present invention;

FIGS. 2A through 2C are isometric views, in exploded form, of examples of different sheets, which are brought together to form the blister pack, illustrated in FIG. 1;

FIGS. 3A through 3C are plan views, of examples of the different sheets, illustrated in FIGS. 2A through 2C;

FIG. 4 is an exemplary method of forming the blister package illustrated in FIG. 1;

FIG. 5 is a partial cross-sectional side view of two adjacent blister recesses;

FIG. 6 is an alternative embodiment of a partial cross-sectional side view of several adjacent blister recesses;

FIG. 7 is a partial plan view of one embodiment of a blister package, in accordance with the present invention, where each usage grouping includes the medication components found in each blister recess for a particular row;

FIG. 8 is a partial plan view of one embodiment of a blister package, in accordance with the present invention, where each row includes two usage groupings;

FIG. 9 is a partial plan view of a further embodiment of a blister package, in accordance with the present invention, where each row includes two usage groupings, and where between the two groupings, each grouping is comprised of a different number of medication components;

FIG. 10 is a partial plan view of one embodiment of a blister package, in accordance with the present invention, where each usage grouping includes medication components found in multiple blister recess rows;

FIG. 11 is a partial plan view of one embodiment of a blister package, in accordance with the present invention, where one of the cover sheets is partially torn away, thereby releasing the medication components of a specific usage grouping;

FIGS. 12A and 12B are plan views of examples of different sheets, which are brought together to form a blister package, in accordance with an alternative embodiment of the present invention; and

FIGS. 13A and 13B are isometric views, in exploded form, of examples of the different sheets, illustrated in FIGS. 12A and 12B;

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

FIG. 1 illustrates an isometric view of one example of a blister package 10 for separately storing and dispensing together separate medication components, in accordance with the present invention. The blister package 10 includes multiple blister recesses 12, within which medication components can be received. The blister package 10 further includes a plurality of cover sheets 14, each cover sheet 14 covering all of the one or more blister recesses 12 containing the medication components of a specific usage grouping.

By applying a shearing force and pulling back at least a portion of one of the cover sheets 14, the medication components located in the corresponding blister recesses 12 are released for use by the user. In this way multiple medication components, which are stored separately, can be dispensed together. Furthermore the multiple medication components can be readily dispensed with minimal confusion to the user. In at least one embodiment, once the cover sheet 14 is pulled back and the medication components are released, the cover sheet 14 cannot be resealed, and therefore the released medication components must be used or disposed of in some way.

For purposes of the present invention a shearing force is defined as a force, which includes a substantial component lateral to the normal direction of the holding force. In the present application a shearing force is applied between the cover sheet 14 and a backing sheet 16 by lifting and folding over the edge of the cover sheet 14 and pulling back.

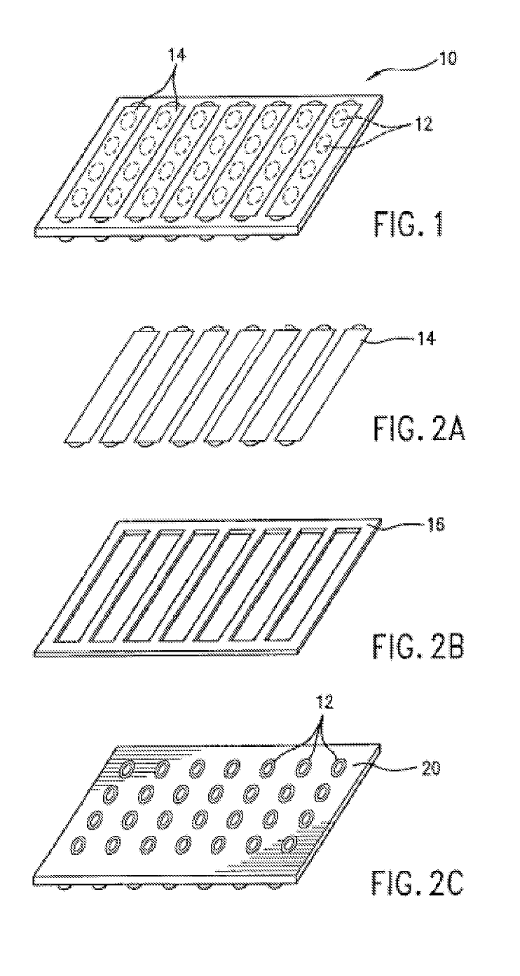

As illustrated in FIGS. 2A through 2C, in at least one embodiment, the cover sheets 14 are secured to a backing sheet 16, which has one or more openings 18, each opening corresponding to one or more blister recesses 12. The blister recesses 12 are formed in a blister sheet 20. By releasing the multiple medication components associated with a particular usage, together at the same time, much of the confusion associated with taking multiple medications is significantly diminished. This of course requires preplanning when the medication components are packaged with knowledge as to how and when the medication components are going to be used.

While in some instances the packaging system will be highly specific to a particular user, in other instances, where the likelihood of using two or more particular medication types together is relatively large, the anticipated volumes may warrant making such a prepackaged combination commonly available.

There are several instances where multiple medication components, which are stored separately, but are taken together, may be beneficial. These instances include situations, where the taking of two medication components together enhance the effectiveness of one or both of the medication components. Further instances include situations, where one of the medications is being used to eliminate or reduce a side effect of the other medication. In other instances it may be beneficial to keep the two components separate until just prior to use. In some instances complete physical isolation may be desirable, while in other instances it may be sufficient to prevent the two components from coming into physical contact with one another.

Several specific examples, where multiple medication components being used together is beneficial, includes the use of certain beta blockers like propranalol, atenolol, bisoprolol and metoprolol, with certain diuretics like hydrochlorothiazide and furosemide; the use of certain nonsteroidal anti-inflammatory drugs like ibuprofen, piroxicam, diclofenac, sulindac and indomethacin, with certain proton pump inhibitors like omeprazole and lansoprazole; the use of certain oral-diabetic agents like glyburide and glipizide along with metformin; and the use of certain anti-rejection drugs like cyclosporin and tacrolimus with certain types of steroids like prednisone. Various combinations of these types are well suited for use with the packaging system of the present invention.

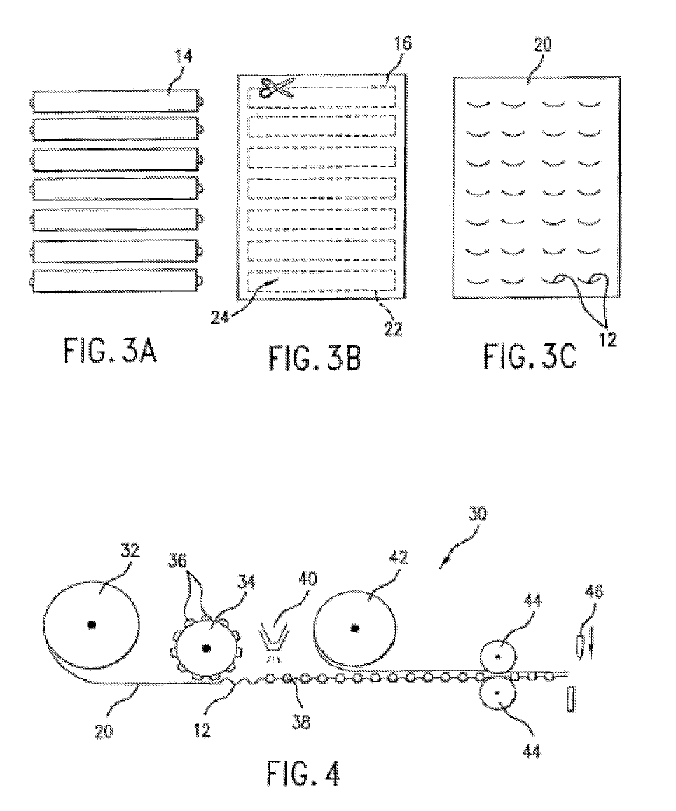

FIGS. 3A through 3C illustrate plan views of the various sheet layers in the embodiment illustrated in FIG. 1. Namely, FIG. 3A illustrates the cover sheets 14, FIG. 3B illustrates the backing sheet 16, and FIG. 3C illustrates the blister sheet 20. The backing sheet 16 is shown with a series of rectangles formed using dashed lines 22. The dashed lines 22 correspond to where holes 24 are cut into the backing sheet 16, in the particular illustrated embodiment. While the holes 24 are shown corresponding generally to an entire row of blister recesses 12, instead of one relatively larger hole 24, it is possible to use several smaller holes, which are each more closely associated with a fewer number of blister recesses 12. A plurality of holes 24 can also be used in conjunction with the blister recesses 12 associated with the same or a specific medication component usage grouping.

The cover sheets 14 are typically affixed to the backing sheet 16, and the backing sheet 16 is then merged with the blister sheet 20.

FIG. 4 illustrates one exemplary apparatus 30 and method by which the blister package 10 of the present invention can be manufactured. Generally the packaging is formed using well known food safe materials. These food safe materials not only include the materials from which the various sheet layers are formed, but also the glues/adhesives used to bond the various sheet layers together. Preferably the cover sheet 14 and/or the backing sheet 16 are formed from materials, upon which information can be printed. Presumably, the printing materials including the ink and/or pigments used to print the information onto the cover sheet 14 and/or the backing sheet 16 are also food safe. In at least one embodiment the blister sheet 20 is formed from either polyethylene or polypropylene. The backing sheet 16 is formed from an aluminum foil.

In the illustrated embodiment, a first roll of material 32 from which the blister sheets 20 are formed is unrolled. Blister recesses 12 are then formed into the blister sheet 20 using a grooved wheel 34. In at least some instances heat is applied to the blister sheet 20 at the same time the blister recesses 12 are being formed.

The blister recesses 12 can be the same or different sizes, and largely depend upon the size and the location of the grooves 36 in the grooved wheel 34. The appropriate medication component 38 is then received by each of the blister recesses 12, via a medication dispensing outlet 40.

A roll of material 42 including backing sheet material is overlaid on top of the blister sheet 20. In at least one embodiment the backing sheet material has been pre-cut to already include the holes 24, and the cover sheets 14 have already been affixed thereto. In at least a further embodiment the desired information has also already been printed onto the backing sheet material. This information can include usage instructions like frequency of use, the time of day and/or the day of the week the particular dosage should be used. The information can further include patient information, or information specific to the type of medication.

The pair of layers are then sealed together using a pair of sealing rollers 44, which applies pressure to both layers. In some instances the layers are sealed using heat. In other instances an adhesive is applied between the two layers prior to entering the rollers 44. Depending upon the specific manner in which the layers are sealed, the surface of the sealing rollers 44 are formed, so as to insure the integrity of the blister recesses 12 and the medication components 38 contained therein are not compromised. For example, in some instances, the surfaces of the sealing rollers 44 are smooth, as shown. In other instances, one or more of the sealing rollers include depressions or grooves to accommodate the blister recesses previously formed. A cutter 46 then subsequently cuts the merged layers to the desired size and shape.

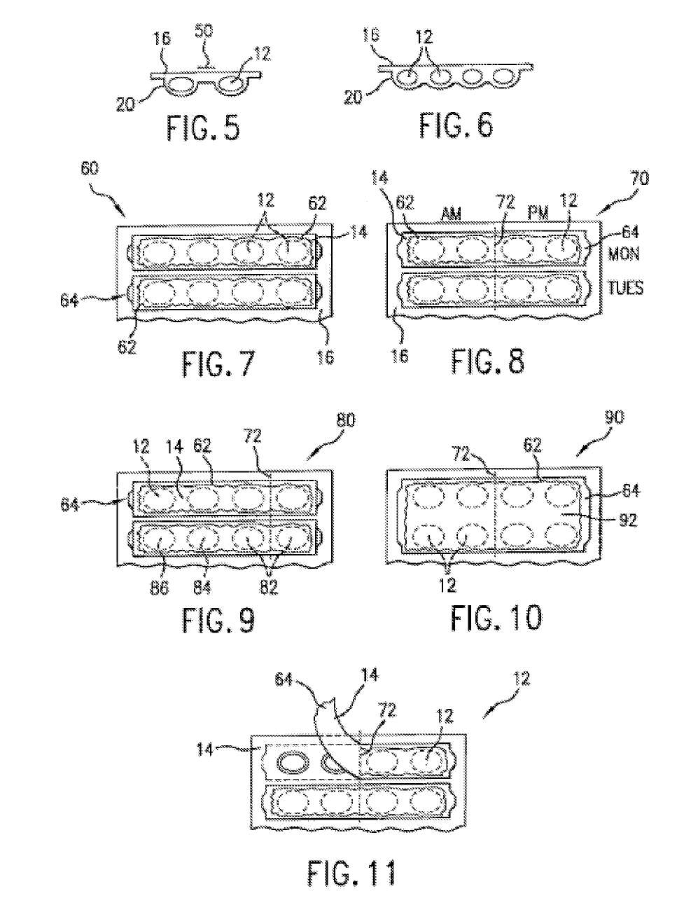

FIGS. 5 and 6 illustrate partial cross-sectional side views of several adjacent blister recesses 12 for alternative embodiments. In FIG. 5, each of the blister recesses 12 are separately sealed 50, so as to substantially physically isolate medication components in one blister recess 12 from medication components in another adjacent blister recess 12. Similarly the medication components in the blister recesses are substantially physically isolated from the external environment. Not only is physical contact substantially prevented between elements which are sealed away from one another, but the physical isolation can include protection from humidity, light and temperature differences.

In FIG. 6, while each of the medication components in the adjacent blister recesses 12 are prevented from coming into contact with one another, odors and/or humidity in the form of gaseous vapors can pass between the two. However similar to FIG. 5, the medication components in the blister recesses 12 are generally substantially physically isolated from the external environment. Separation of the different medication components can be achieved by insuring that any opening that exists between two adjacent blister recesses 12 is too small to enable the captured medication components to pass between corresponding adjacent recesses 12.

The nature of the sealing between adjacent blister recesses 12 is, similar to the determination of the size and shape of the blister recesses 12, largely determined by the profile and location of the grooves 36 in the grooved wheel 34.

FIG. 7 illustrates a partial plan view of one embodiment of a blister package 60, in accordance with the present invention, where each usage grouping includes the medication components found in each of the blister recesses for a particular row. In addition to illustrating the cover sheet 14 adhered to the backing sheet 16, the seam 62 adhering the cover sheet 14 to the backing sheet 16 is similarly shown. In at least one embodiment the sealing force or adhesive used to form the seam 62 is of the type that will readily give way when a shearing force is applied. Proximate the ends of the cover sheet 14 the seam is far enough away from the edge 64 to enable a user to grip the cover sheet 14 and apply the necessary shearing force. Once the shearing force is applied, the cover sheet 14 will at least partially release from the backing sheet 16, thereby allowing the medication components of the specific usage grouping to be released.

FIG. 8 illustrates a partial plan view of a further embodiment 70 of a blister package, in accordance with the present invention, where each row includes two usage groupings. One usage grouping is designated AM, and the other usage grouping is designated PM. Between the two usage groupings is a further seam 72 formed from an adhesive which is capable of resisting the shearing force. This prevents the cover sheet 14, when pulled from one edge 64 from releasing the medication components for both usage groupings. FIG. 11 illustrates an example of one end of the cover sheet having been removed up to the resistant seam 72.

A packaging configuration of this type could, for example, enable each row to correspond to a different day's medication, and a separate portion of the row to correspond to the medication to be taken at two different times during the day.

Alternatively, instead of using an adhesive, which is capable resisting a shearing force for segregating the two usage groupings, the cover sheet could be sufficiently weakened along a similar line 72 or area. This would enable the cover sheet 14 to tear away prior to the shearing force being translated to the portion of the cover sheet 14 beyond the weakened line.

In at least one embodiment a weakened line or area could made by scoring the material used to form the cover sheet 14. In at least another embodiment the cover sheet could be perforated along the weakened line or in the weakened area. In yet a further embodiment, strands of strengthening fibers could be interrupted or diminished at the points where the weakened lines/areas are formed. In any event the force required to cause the cover sheet 14 to tear at the weakened line/area should be less than the amount of shearing force required to separate the cover sheet 14 from the backing sheet 16.

In some instances it may be inappropriate to use perforations for forming the weakened line/area. This is the case where perforations may compromise the integrity in the seal between the cover sheet 14 and the backing sheet 16, and where isolation of the medical component(s) from the external environment is important prior to usage.

FIG. 9 illustrates a partial plan view of a still further embodiment 80 of a blister package, in accordance with the present invention, where each row includes two usage groupings, and where each usage grouping within each row is comprised of a different number of medication components. This particular embodiment allows for the organization of medications that may be taken at different frequencies. For example one of the medication components 82 may need to be taken twice a day, while two of the other medication components 84 and 86 may need to be taken only once a day.

FIG. 10 illustrates a partial plan view of yet another embodiment 90 of a blister package, in accordance with the present invention, where each usage grouping includes medication components which can be found in multiple blister recess rows. The cover sheet 92, as well as the shear resistant seam 72, similarly extend across multiple rows.

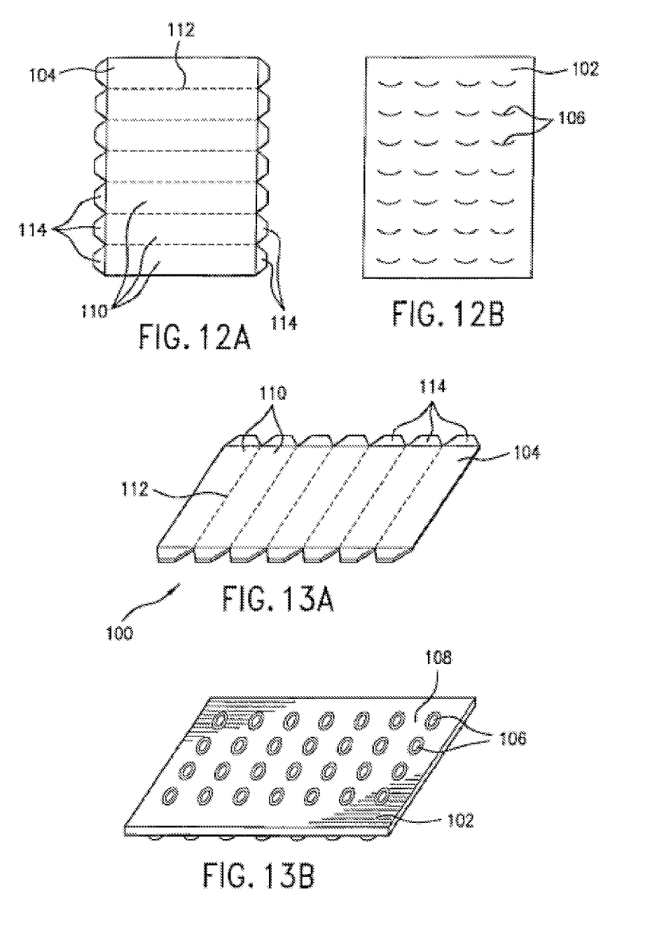

In accordance with an alternative embodiment of the present invention, FIGS. 12A and 12B illustrate a further example of a blister package 100. Specifically, FIGS. 12A and 12B illustrate plan views of both a blister sheet 102 and a segmented backing sheet 104, which together are used to form the alternative blister package 100. FIGS. 13A and 13B illustrate the same blister sheet 102 and segmented backing sheet 104 in isometric view, and exploded form.

The blister sheet 102 includes a plurality of blister recesses 106 within which medication components can be received, and a substantially planer shoulder portion 108, which extends at least partially around the blister recesses 106. The backing sheet 104 substantially adheres to the shoulder portion 108 of the blister sheet 102, which in effect captivates the medication components that are received within the corresponding blister recesses 106.

Whereas the embodiment of the blister package 10, illustrated in FIG. 1, includes a plurality of cover sheets 14, which in combination with openings in a backing sheet 16, allow selective access to the medication components located in a group of blister recesses 12 corresponding to a single specific usage grouping, a similar capability is provided in the alternative blister package 100 by a division of the backing sheet 104 into multiple segments 110, as illustrated in FIGS. 12A and 13A.

The different segments 110 of the backing sheet 104 are divided in at least one embodiment by a weakened line 112 or area located between the different backing sheet segments 110. The weakened line 112 or area can be created by scoring the material used to form the backing sheet 104. The scoring can extend partially or all the way through the material forming the backing sheet 104. Alternatively the backing sheet 104 could be perforated along the weakened line 112 or area.

Yet a further example includes an alteration of the structure which diminishes the integrity of the material used to form the backing sheet 104 along the weakened line 112 or area. This could include the interruption or the diminishment of strengthening fibers used in the material at a point which intersects the area or line 112, where the backing sheet 104 is to be weakened.

The separate medication components associated with a particular usage is grouped together in a manner which corresponds to the backing sheet segments 110. In at least some of the embodiments the medication components corresponding to a specific usage grouping are organized together as part of a common row.

In order to release the medication components associated with a specific usage, one of the backing sheet segments 110 is at least partially removed. Instead of lifting an edge 64 or end portion of the cover sheet 14, as in the embodiment illustrated in FIG. 1, an edge 114 of one of the backing sheet segments 110 is lifted. A shearing force is then applied by the user, which causes the backing sheet segment 110 to peel away from the blister sheet 102, and the backing sheet segment 110 to tear away from the other backing sheet segments 110 along the weakened line 112 or area.

While the illustrated embodiment, shown in FIGS. 12 and 13, includes backing sheet segments 110 organized into rows, one skilled in the art will readily appreciate that other configurations are possible without departing from the teachings of the present invention, including further sub-dividing the segmented rows in a manner similar to the embodiments illustrated in FIGS. 8 through 11.

One skilled in the art will readily appreciate that other types of groupings are similarly possible without departing from the teachings of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A package system for separately storing and dispensing together separate medication components comprising:
a blister sheet including a plurality of blister recesses for receiving a plurality of different medication components, which are grouped in adjacent blister recesses corresponding to prescribed use together on a per dose basis, and a substantially planar non-blistered shoulder portion, which extends around at least portions of the plurality of blister recesses;
a backing sheet having one or more openings, each opening being opposite to and extending to encompass one or more of the blister recesses, which include medication components from the same usage grouping, and a sealing portion which is substantially adhered to the shoulder portion of the blister sheet; and
one or more cover sheets for covering and sealing the one or more openings in the backing sheet, wherein a common cover sheet covers all of the one or more openings opposite the blister recesses containing the medication components of a specific usage grouping.

2. The system in accordance with claim 1 wherein the sealing portion of the backing sheet is adhered to the shoulder portion of the blister sheet using an adhesive or glue.

3. The system in accordance with claim 1 wherein the sealing portion of the backing sheet is adhered to the shoulder portion of the blister sheet by applying heat at the point of contact.

4. The system in accordance with claim 1 wherein the cover sheets are attached to the backing sheet prior to the backing sheet being adhered to the blister sheet.

5. The system in accordance with claim 1 wherein the cover sheets are secured to the backing sheet using a glue, which readily tears away from the backing sheet at least partially when a shearing force is applied to one of the cover sheets.

6. The system in accordance with claim 5 wherein at least one side of the cover sheets are sealed by the glue a sufficient distance away from an edge of the cover sheets to enable the edge of the cover sheet to be gripped by a users fingers for applying a shearing force.

7. The system in accordance with claim 5 wherein, when one of the cover sheets is at least partially torn away, the medication components of the specific usage grouping are released from the package system.

8. The system in accordance with claim 5 wherein, when the cover sheet is sheared away, the cover sheet can not be readily resealed.

9. The system in accordance with claim 1 wherein at least a portion of the cover sheets are secured using an adhesive strong enough to resist a shearing force applied by a user, thereby preventing the complete removal of the cover sheets.

10. The system in accordance with claim 1 wherein the blister recesses containing the medication components for the specific usage grouping are arranged in a row.

11. The system in accordance with claim 1 wherein the cover sheet extends to cover all of the one or more openings opposite the blister recesses containing the medication components for two different usage groupings, and wherein the cover sheet is secured with an adhesive strong enough to resist a shearing force applied by a user along a line separating the two different usage groupings.

12. The system in accordance with claim 11 wherein when a shearing force is applied to the cover sheet on one side of the line separating the two different usage groupings, the cover sheet will sheer away from the blister sheet on that side at least partially up to the line separating the two different usage groupings.

13. The system in accordance with claim 1 wherein the cover sheet extends to cover all of the one or more openings opposite the blister recesses containing the medication components for two different usage groupings, and wherein the cover sheet is weakened along a line separating the two different usage groupings, such that shearing beyond the weakened line is prevented, when a shearing force is applied by a user to one side of the cover sheet.

14. The system in accordance with claim 13 wherein when a shearing force is applied to the cover sheet on one side of the line separating the two different usage groupings, the cover sheet will sheer away from the blister sheet on that side at least partially up to the line separating the two different usage groupings, and the cover sheet will tear at the weakened line prior to shearing beyond the weakened line.

15. The system in accordance with claim 13 wherein along the weakened line the cover sheet includes at least one of a scored line, a perforated line, and strands of strengthening fibers which are broken or diminished at the weakened line.

16. The system in accordance with claim 1 wherein the medication components located in each one of the blister recesses is substantially prevented from coming into contact with the medication components located in the other blister recesses.

17. The system in accordance with claim 1 wherein the medication components located in each one of the blister recesses is substantially physically isolated from the medication components located in the other blister recesses.

18. The system in accordance with claim 1 wherein, prior to the removal of the corresponding cover sheet, the medication components located in each one of the blister recesses is substantially physically isolated from the environment outside of the package system including protection from at least one of humidity, light, and temperature.

19. The system in accordance with claim 1 wherein each of the medication components is in the form of one of a combination of solids, a combination of liquids, and a combination solid and liquid.

20. The system in accordance with claim 19 wherein each of the medication components in the form of a combination of solids includes medication components in at least one of pill form, tablet form, and capsule form.

21. The system in accordance with claim 1 wherein one of the medication components of the usage grouping reduces the side effects associated with another one of the medication components of the usage grouping.

22. The system in accordance with claim 1 wherein at least a couple of the medication components of the usage grouping should be used together for optimal efficacy.

23. The system in accordance with claim 1 wherein at least one of the backing sheet and the cover sheet has product information regarding the medication components including at least one of usage instructions, patient identification indicia, and medication component identification indicia.

24. The system in accordance with claim 19 wherein the product information on the at least one of the backing sheet and the cover sheet includes instructions regarding the day of the week and the time of the day each usage grouping of medication components is prescribed.

25. A package system for separately storing and dispensing together separate medication components comprising:
a blister sheet including a plurality of blister recesses for receiving a plurality of different medication components, which are grouped in adjacent blister recesses corresponding to prescribed use together on a per dose basis, and a substantially planar non-blistered shoulder portion, which extends around at least portions of the plurality of blister recesses;
a backing sheet having a sealing portion which is substantially adhered to the shoulder portion of the blister sheet, wherein the backing sheet is subdivided into one or more segmented portions, each segmented portion being opposite to, and extending to encompass and substantially seal one or more of the blister recesses, which include all of the medication components of a specific usage grouping.

26. A package system in accordance with claim 25 wherein the segmented portions of the backing sheet are defined by weakened areas in the backing sheet along which the backing sheet tears as a shearing force is applied by the user to one of the segmented portions.

27. A package system in accordance with claim 26 wherein the at least some of the weakened areas are formed by scoring the backing sheet along the line separating two adjacent segments.

28. A package system in accordance with claim 26 wherein at least some of the weakened areas are formed by perforating the backing sheet along the line separating two adjacent segments.

29. A package system in accordance with claim 26 wherein the backing sheet includes strands of strengthening fibers which run the length along the length of the backing sheet, and wherein at least some of the weakened areas in the backing material are formed by breaking or diminishing the integrity of the strengthening fibers along the area separating two adjacent segments.

30. A package system in accordance with claim 25 wherein when a shearing force is applied to one of the segments of the backing sheet, the corresponding segment tears away from the blister sheet.

31. The system in accordance with claim 25 wherein the medication components located in each one of the blister recesses is substantially prevented from coming into contact with the medication components located in the other blister recesses.

32. The system in accordance with claim 25 wherein the medication components located in each one of the blister recesses is substantially physically isolated from the medication components located in the other blister recesses.

33. The system in accordance with claim 25 wherein, prior to the removal of the segment of the backing sheet, the medication components located in each one of the blister recesses is substantially physically isolated from the environment outside of the package system including protection from at least one of humidity, light, and temperature.

34. The system in accordance with claim 1 wherein the backing sheet has product information regarding the medication components including at least one of usage instructions, patient identification indicia, and medication component identification indicia.

35. The system in accordance with claim 19 wherein the product information on the backing sheet includes instructions regarding the day of the week and the time of the day each usage grouping of medication components is prescribed.
